(19) United States
(12) Patent Application Publication
(10) Pub. No.: US 2003/0020838 A1
(43) Pub. Date: Jan. 30, 2003

(54) ELECTRONIC CONSUMER APPARATUS HAVING FAST MEMORY ACCESS MEANS

(75) Inventors: PATRICK GOUJON, SURESNES (FR); CHRISTOPHE MARTIN, PARIS (FR)

Correspondence Address: U S PHILIPS CORPORATION, 580 WHITE PLAINS ROAD, TARRYTOWN, NY, 10591

(73) Assignee: U.S. PHILIPS CORPORATION

(21) Appl. No.: 09/233,840

(22) Filed: Jan. 20, 1999

(30) Foreign Application Priority Data
Jan. 21, 1998 (FR) 9800615

(51) Int. Cl. H04N 7/20; H04N 5/253; H04N 5/257; H04N 9/47; H04N 7/173; H04N 7/16; H04N 9/64

(52) U.S. Cl. 348/714; 725/132; 725/140; 725/152

(57) ABSTRACT

The apparatus comprises a processor (15) which has specialized high-speed link terminals intended for the network communication with another processor linked to a rewritable application program memory (26) and includes means for updating this memory. The apparatus includes a connector (30) linked to said high-speed terminals and enabling the communication to the exterior.

The present invention relates to a method of loading and updating a rewritable application program memory in an electronic consumer apparatus comprising a processor linked to said memory, including means for processing video signals and digital data sent by a television transmitter.

The invention also relates to an electronic consumer apparatus intended to enable reception and decoding of video signals sent by a television transmitter, comprising a processor linked to a rewritable application program memory and including means for updating this memory, and notably a video receiver comprising a processor including means for receiving and decoding video signals sent by a television transmitter, linked to a rewritable application program memory and including means for updating this memory.

Apparatus as defined in the opening paragraph are known from the abstract, pages 31-32 and FIG. 5b of PCT WO 94/13107. In these apparatus, a memory may be updated by means of a serial link, for example, of the type RS232 or RS422.

It is an object of the invention to increase the speed of data transfer to the memory in order to enable its loading during a manufacturing process in a reasonably short period of time.

For this purpose, according to the inventive method, while the processor has specialized high-speed link terminals intended for network communication with another processor, these terminals are used for loading and updating the program memory.

The invention is thus based on the idea of “diverting” the use of terminals initially provided for quite another use. Thanks to the use of these terminals, only four connections are necessary for loading the memory and emptying is very fast.

Particular embodiments of the method will be apparent from dependent claims 2 and 3.

An apparatus, notably a video receiver according to the invention, whose processor has specialized high-speed link terminals intended for the network communication with another processor, includes a connector linked to said terminals and enabling the communication to the exterior.

Particular embodiments of the apparatus appear in the dependent claims 6 to 9.

These aspects of the invention and also more detailed other aspects will appear more distinctly thanks to the following description of an embodiment which forms a non-exhaustive example.

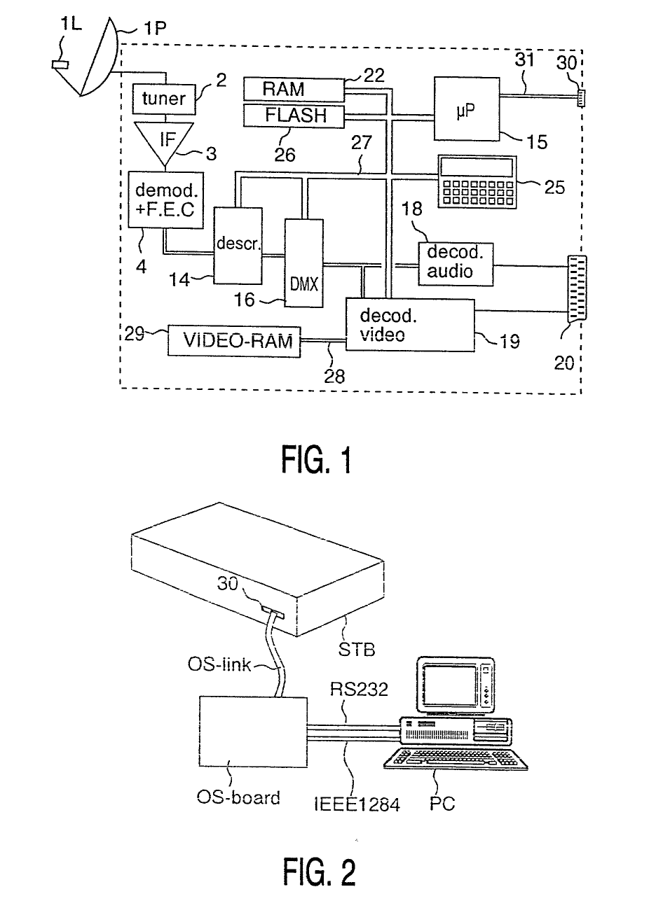

FIG. 1 diagrammatically shows a video receiver; and

FIG. 2 represents an assembly formed by a video receiver, a maintenance board and a maintenance computer.

The apparatus represented by way of example in FIG. 1 is a television receiver/decoder. It is obvious that the invention would also be applied to other types of electronic consumer apparatus.

The receiver is connected to a parabolic antenna 1P which includes a frequency transposition module 1L and comprises a tuner 2, followed by an intermediate frequency amplifier 3. The intermediate frequency signal is demodulated and certain errors are corrected in a module 4 after which the signal is finally descrambled in a descrambling module 14. The output signal of the descrambling module 14 is subjected to the action of a demultiplexer 16 which selects a program. The output signal of this demultiplexer is transformed in a video decoder 19 and in a sound decoder 18 into analog signals which are taken to a video connector 20 positioned, for example, on the back of the receiver for a link to a conventional television set. By way of variant, the elements of the Figure could also be internal elements of a television set. While they are being processed in the decoder 19, the video signals may be stored in a video memory 29 connected to the decoder 19 by a bus 28.

A processor 15 is connected by a bus 27 to a “flash” program memory 26 in which are written, inter alia, the instructions thanks to which the processor can function, to a random access memory 22 for provisionally storing data, and to a user-dialogue assembly 25 comprising, for example, a control keyboard associated to a data display panel or also a remote control receiver. The instructions in the application program memory 26 are saved when the receiver is switched off, but may be updated. They must also be loaded while the receiver is being manufactured.

The processor 15 has a core of a special type, known per se, called “transputer”, which has specialized high-speed link terminals called OS-links intended for the network communication with another processor, in the case of a structure of various processors in a matrix configuration. This is not the case here, but the presence of these terminals enables a much faster link to the exterior; they additionally enable a dialogue with the processor even when the latter does not contain any software element. As a reminder: in a conventional processor, software elements must always be present to enable at least the data transfer via the processor. The use of these terminals is thus particularly interesting for the test of a receiver, because they enable the verification of the data and the address bus even if there is a problem on a bus such as a short-circuit, open connection, etc., in cases where the software of the receiver cannot be started and where it would be very difficult to diagnose and repair.

The high-speed link terminals are connected via a link 31 to a connector 30 situated, for example, underneath the receiver or on the back of the receiver. The connector 30 comprises four conductors, for ground, signal input, signal output and for passing booting signals respectively, and possibly a fifth conductor for passing signals for cancelling the flash memory protection.

An operation of software loading or flash memory updating or testing may be realized by means of the equipment represented in FIG. 2. A computer PC contains the data and the instructions necessary for carrying out the operation. It is linked by an RS232 bus and/or an IEEE1284 bus to an intermediate module, referenced OS-board, itself connected by a link, referenced OS-link, to the connector 30 of a receiver STB during manufacturing, during a test, or during an update. The module OS-board contains hardware interfaces and a processor with software and memories for formatting and transmitting the instructions from the computer to the link OS-link. It may, amongst others, contain various memories for storing the software of various types of receivers and selecting the ad hoc memory as a function of the receiver during manufacturing, update or test. When the operation is terminated, it sends an acknowledgement to the computer.

Thanks to the speed of the link OS-link (20 Mbits/sec), the following performance may be obtained with a 32-bit access flash memory:

2 Mbyte programming: 8.6 seconds

1 Mbyte programming: 4.5 seconds with a 16-bit access flash memory:

1 Mbyte programming: 8.6 seconds.

These times include the check time after programming.

Thanks to the thus obtained short programming time it is possible to program the flash memories on a manufacturing line at low cost. In practice, it is the memory itself that limits the speed of the operation.

1. A method of loading and updating a rewritable application program memory in an electronic consumer apparatus comprising a processor linked to said memory, characterized in that with the processor having specialized high-speed link terminals intended for network communication with another processor, these terminals are used for loading and updating the program memory.

2. A method as claimed in claim 1, characterized in that it is implemented at the factory for loading software in the memory during a manufacturing process.

3. A method as claimed in claim 2, characterized in that it is implemented for updating or testing the memory.

4. An electronic consumer apparatus comprising a processor linked to a rewritable application program memory and including means for updating this memory, characterized in that with the processor having specialized high-speed link terminals intended for the network communication with another processor, the apparatus includes a connector linked to said terminals and enabling the communication to the exterior.

5. A video receiver comprising a processor which includes means for receiving and decoding video signals sent by a television transmitter, linked to a rewritable application program memory and includes means for updating this memory, characterized in that with the processor having specialized high-speed link terminals intended for the network communication with another processor, the receiver includes a connector linked to said terminals and enabling the communication to the exterior.

6. An electronic consumer apparatus as claimed in claim 4, characterized in that the terminals are OS-link terminals.

7. An electronic consumer apparatus as claimed in claim 4, characterized in that the memory is a “flash” memory.

8. A video receiver as claimed in claim 5, characterized in that the terminals are OS-link terminals.

9. A video receiver as claimed in claim 5, characterized in that the memory is a “flash” memory.
